(19) United States
(12) Patent Application Publication
(10) Pub. No.: US 2011/0063453 A1
(43) Pub. Date: Mar. 17, 2011

(54) SHOT TRANSITION DETECTION METHOD AND APPARATUS

(75) Inventors: Bo HAN, Beijing (CN); Weiguo Wu, Beijing (CN)

(73) Assignee: SONY CORPORATION, Tokyo (JP)

(21) Appl. No.: 12/882,639

(22) Filed: Sep. 15, 2010

(30) Foreign Application Priority Data
Sep. 16, 2009 (CN) 200910176225.1

(51) Int. Cl. H04N 17/00

(52) U.S. Cl. 348/180; 348/E17.001

(57) ABSTRACT

The present invention discloses a shot transition detection method and a shot transition detection apparatus. The shot transition detection method includes an inter-frame feature differential sequence generation step of generating a plurality of inter-frame feature differential sequences with different differential scales based on a video, wherein lengths of at least two inter-frame feature differential sequences of the plurality of inter-frame feature differential sequences are greater than or equal to 2; and a shot transition detection step of detecting a shot transition in the video by an association of the plurality of inter-frame feature differential sequences. The present invention is capable of detecting a shot transition in a video effectively.

### FIELD OF INVENTION

The present invention relates to processing and analyzing a video, in particular to detecting a shot transition in a video.

### BACKGROUND OF THE INVENTION

Along with constant increases in capacity of a memory device and in bandwidth of a network, video contents with abundant information have been increasingly widely applied, and have become an indispensable part in people's life. The video content is generated, spread and stored at a speed never before known.

The purpose of storage is to reuse. However, the richer the video content is, the cockamamie the reuse will be. Under such a background, managing, browsing, indexing and searching of a video that completely depend upon manpower become quite difficult and unpractical. Therefore, an automatic analysis and search technology for video content which is capable of helping people to find out quickly a desired video has a widely applicable prospect.

In an analysis of a video edited manually, the most suitable semantic unit presently universally recognized is a shot; and the shot refers to a group of internally correlated frames shot by one camera continuously, and is used to represent a group of contents that are spatiotemporally continuous. Due to a limited description capacity of the shot, most edited videos are formed of connecting a number of shots temporally. Transitions among different shots cause a change of a scene (place or time), and the purpose of the shot transition detection is to divide in time domain a video sequence into basic semantic units, i.e. the shots.

There are two types of shot transitions: abrupt transition and gradual transition (referred to as GT for short). The abrupt transition is also generally referred to as cut, and refers to a circumstance that the last frame of a previous shot is connected directly to the first frame of a next shot. Of course, in an interlaced scanning television broadcasting video, at the cut position there may be one frame formed by an aliasing of the last frame of the previous shot with the first frame of the next shot, and sandwiched between two shots. Moreover, due to a video compression coding, the aliasing effect cannot be removed completely even if this frame is performed with an interlaced sampling. Such a circumstance also belongs to cut.

Unlike the cut, during a gradual transition, the previous shot is transited to the next shot through a continuous multi-frame change process, that is, in the video there are a number of frames which are sandwiched between two adjacent shots and belong to neither of the shots. The conventional types of gradual transition mainly include a fade out/in, a dissolve, a wipe, etc. The fade out refers to that images of the previous shot gradually conceal until the picture is of a single color completely, and then cut to the next shot; and the fade in refers to a shot transition course opposite to the fade out. Of course, the fade out and the fade in may be used together temporally. The dissolve refers to that images of the latter shot gradually enhance while images of the former shot gradually blur, and completes a transition of shots in such a process that images of the former and the latter shots are overlapped. The wipe refers to that images of the latter shot gradually largen starting from a certain region based on a certain rule, until images of the former shot are covered completely. Unlike a conventional wipe, a more complicate wipe process with a fly in and fly out of a graphic logo is referred to as a graphic wipe, also referred to as a logo transition.

There are a number of workings attempting to detect effectively a shot transition in documents.

A method for extracting features for detecting a shot transition based on an inter-frame histogram differential sequence is disclosed in the Enhanced Sports Video Shot Boundary Detection Based on Middle Level Features and a Unified Model, IEEE Trans. Consumer Electronic, vol. 53, no. 3, pp. 1168-1176 published in 2007 and authored by B. Han, Y. Hu, etc. The method uses a single inter-frame histogram differential sequence to extract features for detecting a shot gradual transition with a specific length.

### SUMMARY OF THE INVENTION

A brief summary about the present invention is provided hereinafter to provide basic understandings related to some aspects of the present invention. It shall be understood that this summary is not an exhaustive summary related to the present invention. The summary is not intended to determine a key part or an important part of the present invention, nor does it intend to limit the scope of the present invention. The purpose of the summary is only to provide some concepts in simplified forms to prelude more detailed descriptions discussed later.

An object of the present invention is to provide a new method and apparatus for detecting a shot transition in a video.

According to one aspect of the present invention, a shot transition detection method is provided, the method comprising: an inter-frame feature differential sequence generation step of generating a plurality of inter-frame feature differential sequences with different differential scales based on a video, wherein lengths of at least two inter-frame feature differential sequences of the plurality of inter-frame feature differential sequences are greater than or equal to 2; and a shot transition detection step of detecting a shot transition in the video by an association of the plurality of inter-frame feature differential sequences.

According to one aspect of the present invention, a shot transition detection apparatus is provided, the apparatus comprising: an inter-frame feature differential sequence generation unit configured to generate a plurality of inter-frame feature differential sequences with different differential scales based on a video, wherein lengths of at least two inter-frame feature differential sequences of the plurality of inter-frame feature differential sequences are greater than or equal to 2; and a shot transition detection unit configured to detect a shot transition in the video by an association of the plurality of inter-frame feature differential sequences.

In addition, embodiments of the present invention further provide a computer program for implementing the method for detecting a shot transition in a video.

According to one aspect of the present invention, a computer-readable medium is provided, on which is stored computer instructions which, when executed by a computer, cause the computer to perform the above shot transition detection method.

Furthermore, embodiments of the present invention further provide at least a computer program product in the form of a computer readable medium, on which a computer program code for implementing the method for detecting a shot transition in a video is recorded.

The present invention can detect effectively a shot transition in a video.

### BRIEF DESCRIPTION OF THE DRAWINGS

Referring to the explanations of the present invention in conjunction with the Drawings, the above and other objects, features and advantages of the present invention will be understood more easily. Components in the Drawings are only intended to illustrate the principle of the present invention. In the Drawings, the same or similar technical features or components are represented by the same or similar reference signs.

FIG. 1 illustrates a method for detecting a shot transition in a video in accordance with the first embodiment of the present invention;

FIG. 2 is a schematic view of a multi-scale association feature used in the method for detecting a shot cut in a video in accordance with the first embodiment of the present invention;

FIG. 3 is a schematic view of a multi-scale association feature used in the method for detecting a shot gradual transition in a video in accordance with the first embodiment of the present invention;

FIG. 4 illustrates a method for detecting a shot transition in a video in accordance with the first embodiment of the present invention;

FIG. 5 illustrates an example of a three scale (8, 16, 32) association feature corresponding to a shot transition with a length of 16;

FIG. 6 illustrates graphically an exemplary structure of a computer equipment which can be used for implementing an apparatus for detecting a shot transition in a video of the present invention; and

FIG. 7 illustrates a shot transition detection apparatus in accordance with the fifth embodiment of the present invention.

### DESCRIPTION OF THE PREFERRED EMBODIMENTS

The embodiments of the present invention are discussed hereinafter in conjunction with the Drawings. Elements and features described in one Drawing or one embodiment of the present invention may be combined with elements and features described in one or more other Drawings or embodiments. It shall be noted that representation and description of components and processes unrelated to the present invention and well known to one of ordinary skill in the art are omitted in the Drawings and the Description for the purpose of being clear.

The new type feature for detecting a shot transition in a video provided in the present invention is based on an inter-frame feature difference. The so-called inter-frame feature difference refers to a difference between values of two different frames related to the same feature. A conventional feature of a frame is the color histogram. A region color histogram is taken as an example to introduce a calculating method of the inter-frame feature difference hereinafter.

The color histogram is a vector with a specific number of bins, in which a value of each bin is representative of a frequency of a color to which this bin corresponds presenting in the pixel set generating this histogram. The color histogram difference is used to represent a difference between two color histograms. There may be a number of manners defining the histogram difference, and Bin-to-Bin (B2B for short) and Chi-square (that is, χ², referred to as Chi2 for short) are the conventionally used two types. Their definitions are provided as follows:

$$\begin{matrix}{D}_{i}^{B 2 B} ( t , s ) = {\sum }_{j = 1}^{{N}_{i}^{Bin}} \vert {H}_{i} ( t , j ) - {H}_{i} ( t - s , j ) \vert & ( 1 ) \\ {D}_{i}^{Chi 2} ( t , s ) = {\sum }_{j = 1}^{{N}_{i}^{Bin}} \{ \begin{matrix}\frac{{[ \begin{matrix}{H}_{i} ( t , j ) - \\ {H}_{i} ( t - s , j )\end{matrix} ]}^{2}}{max [ \begin{matrix}{H}_{i} ( t , j ) , \\ {H}_{i} ( t - s , j )\end{matrix} ]} , & if max [ \begin{matrix}{H}_{i} ( t , j ) , \\ {H}_{i} ( t - s , j )\end{matrix} ] \neq 0 \\ 0 , & others\end{matrix} & ( 2 )\end{matrix}$$

Wherein D is representative of an inter-frame histogram difference, t is representative of a serial number of a current frame, s is representative of a difference between serial numbers of two frames, that is, a distance between two frames on a time axis, which is also referred to as a differential scale or scale, i denotes a serial number of a region in an image, H is representative of a histogram, Nᵢ^{Bin} denotes the number of bins of the color space divided by the histogram to which the region i corresponds, and j is representative of serial numbers of bins in the histogram.

In a specific calculation, first of all, a number of regions are extracted respectively from two frames, and a pixel set is extracted from each region. Then each pixel set is converted into a specific color space, for example, Hue-Saturation-Value (HSV) or Hue-Saturation-Intensity (HSI), and a corresponding histogram is generated respectively for each pixel set in a division manner of the color space. Then a difference between histograms of the regions to which two frames correspond is calculated based on the above formulae (1) and (2). At last, a weighted sum of differences of histograms in each region is calculated as a differential value of histograms between two frames, that is:

$$D ( t , s ) = {\sum }_{i = 1}^{{N}^{Region}} {w}_{i} {D}_{i} ( t , s ) \qquad ( 3 )$$

Wherein, N^{Region} is representative of the number of region extracted from an image, and w, is representative of a weight of the histogram difference of the region i.

More specific details of calculating inter-frame histogram difference can be implemented by a person skilled in the art, and detailed descriptions are omitted here.

The so-called inter-frame histogram differential sequence refers to a sequence formed by a change of an inter-frame histogram difference D(t, s) over t with the same s value.

It is discovered by the applicant that if a feature for detecting a shot transition is extracted using only an inter-frame feature differential sequence with a single scale when detecting a shot transition with a specific length, a part of useful information may be lost, so that the correctness of detection will not be facilitated. Therefore, the present invention proposes to detect a shot transition using an association of a plurality of inter-frame feature differential sequences with different scales.

The method and apparatus for detecting a shot transition in a video of the present invention are introduced hereinafter in conjunction with specific embodiments.

### Method for Detecting a Shot Transition in a Video

### The First Embodiment

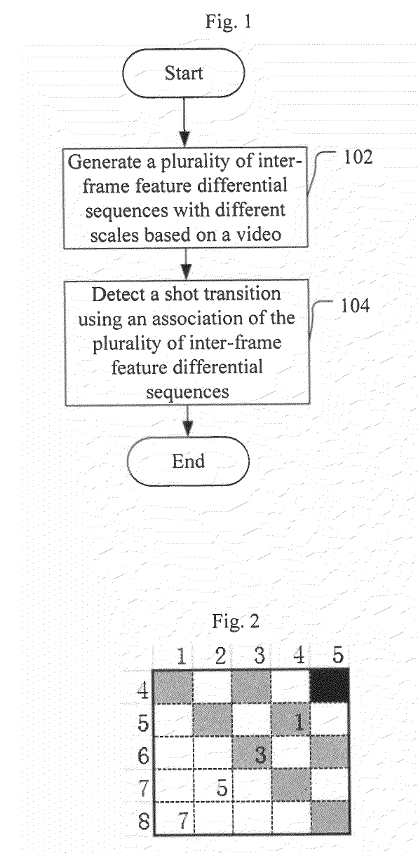

FIG. 1 illustrates a method for detecting a shot transition in a video in accordance with this embodiment. The method comprises an inter-frame feature differential sequence generation step 102 and a shot transition detection step 104. In the step 102, generate a plurality of inter-frame feature differential sequences with different differential scales based on a video, wherein lengths of at least two inter-frame feature differential sequences of the plurality of inter-frame feature differential sequences are greater than or equal to 2. In the step 104, detect a shot transition in the video by an association of the plurality of inter-frame feature differential sequences. Although a single inter-frame feature differential value may reflect whether a shot transition exists or not to some extent, the information as included therein is quite limited. In order to reflect more effectively whether a shot transition exists or not, and information such as a length, a position, and a type of the shot transition, a change of the inter-frame feature differential value in the time axis shall be considered. The sequence with a length greater than or equal to 2 may be regarded as a “really effective” sequence. Therefore, in this embodiment, wherein lengths of at least two inter-frame feature differential sequences of the plurality of inter-frame feature differential sequences are greater than or equal to 2, so that an association of “really effective” inter-frame feature differential sequences may be formed, so as to perform a detection of a shot transition more effectively.

In one example of this embodiment, in case of detecting a shot cut, in the step 102, generate inter-frame feature differential sequences with the following two scales (1 and s₂) based on a video:

$$\{ \begin{matrix}\{ D ( t , 1 ) \vert t = x - 1 , x , x + 1 \} \\ \{ D ( t , {s}_{2} ) \vert t = x - 1 , x , x + 1 , … , x + {s}_{2} \}\end{matrix} \qquad ( 4 )$$

Wherein, D is representative of an inter-frame feature difference, t is representative of a serial number of a current frame, and s₂ is greater than 1. The D(t, 1) is representative of a feature difference between the frame t and the frame t−1. The D (t, s₂) is representative of a feature difference between the frame t and the frame t−s₂. The sequence {D(t,1)|t=x−1,x,x+1} is the {D(x−1,1),D(x,1),D(x+1,1)}, hereinafter referred to as {D(t,1)} for short. Similarly, the sequence {D(t,s₂)|t=x−1,x,x+1,x,x+1, . . . , x+s₂} is the {D(x−1,s₂), D(x,s₂), D(x+1,s₂), . . . , D(x+s₂,s₂)}, hereinafter referred to as {D(t,s₂)} for short. An association of the {D(t,1)} and the {D(t,s₂)} may be referred to as a multi-scale association feature for detecting a shot transition.

Two sequences in formula (4) may be used to detect whether a shot cut occurs before the x frame, that is, whether the x frame is the first frame of the shot following closely the shot cut.

In the step 104, an association of the {D(t,1)} and the {D(t,s₂)} is used to detect a shot transition in a video. For example, a shot transition may be detected using a classifier obtained by training with the two inter-frame feature differential sequences or mathematical transformations of the two inter-frame feature differential sequences as features. Wherein, the mathematical transformations of the two inter-frame feature differential sequences may be transformations constituted of, for example, an addition, a subtraction, a multiplication, a division, a power function, an exponent, a logarithm among corresponding inter-frame feature differential values of the two inter-frame feature differential sequences and the combination of the above mathematical transformations. The classifier is a classifier obtained by training with the inter-frame feature differential sequences {D(t,1)} and {D(t,s₂)} or mathematical transformations of the two inter-frame feature differential sequences as features based on a reliable sample set (for example, a sample set obtained through manual marks). The classifier may be obtained, for example, based on a support vector machine (SVM). After an input of the inter-frame feature differential sequences {D(t,1)} and {D(t,s₂)}, the classifier may output a probability of an occurrence of shot cut before x frame of the video. One of ordinary skill in the art can implement the specific training methods and using methods of the classifier after reading this Description, and thus the detailed descriptions thereof are omitted here. In addition, in one example, before or after inputting the inter-frame feature differential sequences {D(t,1)} and {D(t,s₂)} obtained in step 102 to the classifier, processing and treating of the data are performed in accordance with classification requirements.

FIG. 2 is a schematic view of a multi-scale association feature used in the method for detecting a shot cut. In FIG. 2, each bin is representative of one possible inter-frame feature difference, and the row serial number and the column serial number corresponding thereto are respectively representative of serial numbers of the two images being performed with feature difference, and the figure in the bin is representative of a scale of the feature difference; the black bin represents that the feature difference corresponding thereto has an overlapping with a certain non-black bin located at its lower left side, and the charcoal grey bin represents that the corresponding inter-frame feature difference is used as a part of multi-scale association features (that is, a plurality of sequences with different differential scales) for detecting a shot cut. It can be seen that the x in this example is 5, and the two scales are respectively 1 and 3.

In the above example, detect a shot transition using an association of two inter-frame feature differential sequences. However, a shot transition may be detected by using three or more inter-frame feature differential sequences. In particular, in case of detecting a shot transition by using three or more inter-frame feature differential sequences, the mathematical transformations of the inter-frame feature differential sequence that may be used in step 104 may be mathematical transformations of any two or more inter-frame feature differential sequences.

This embodiment is not limited to the construction method of the sequence association in the above formulae (4), for example, the sequence association as follows may also be constructed for detecting a shot cut.

$$\{ \begin{matrix}\{ D ( t , 1 ) \vert t = x - 1 , x \} \\ \{ D ( t , {s}_{2} ) \vert t = x - 1 , x , x + 1 , … , x + {s}_{2} - 1 \}\end{matrix} \qquad ( 5 )$$

The meanings of the symbols in formula (5) are similar to those in the formula (4).

In the formula (4), the video segment corresponding to the sequence D(t,1) is the video segment from the frame x−1 to the frame x+1, that is, the length of the video segment is 3, and the video segment corresponding to the sequence {D(t, s₂)} is the video segment from the frame x−1 to the frame x+s₂, that is, the length of the video segment is s₂+2. In the formula (5), the video segment corresponding to the sequence D(t,1) is the video segment from the frame x−1 to the frame x, that is, the length of the video segment is 2, and the video segment corresponding to the sequence {D(t, s₂)} is the video segment from the frame x−1 to the frame x+s₂−1, that is, the length of the video segment is s₂+1. It can be seen that a length of a video segment which each inter-frame feature differential sequence corresponds to is determined based on a differential scale of the inter-frame feature differential sequence and a corresponding shot transition length to be detected. The sequence associations satisfying this rule will benefit a standardization of the sequence association. However, this embodiment is not limited thereto, and sequence associations not satisfying this rule may also be constructed.

It shall be noted that if two frames of images corresponding to one inter-frame feature differential value are not in the same shot because of an existence of one shot cut, this inter-frame feature differential value will be influenced by this shot cut, or, this inter-frame feature differential value has a certain reflection to the existence of this shot cut. As to an inter-frame feature differential sequence with a larger differential scale, the span of the frames to which all the inter-frame feature differential values influenced by this shot cut relate (that is, the length of the video segment corresponding to this sequence) is relatively large. Therefore, in order to make the limited number of extracted inter-frame feature differential values more effective, a length of a video segment corresponding to an inter-frame feature differential sequence with a larger differential scale may be made to be greater than that of a video segment corresponding to an inter-frame feature differential sequence with a smaller differential scale. It can be seen that in the formulae (4) and (5), a length of a video segment corresponding to an inter-frame feature differential sequence with a larger differential scale is greater than that of a video segment corresponding to an inter-frame feature differential sequence with a smaller differential scale. Of course, this embodiment is not limited thereto, and sequence associations not satisfying this rule may also be constructed. For example, there may be only a part of (at least two) inter-frame feature differential sequences satisfying the rule among the plurality of inter-frame feature differential sequences.

In another example of this embodiment, in case of detecting a shot gradual transition, in the step 102, generate the inter-frame feature differential sequences with the following two scales (s₁ and s₂) based on a video:

$$\{ \begin{matrix}\{ D ( t , {s}_{1} ) \vert t = x - L , … , x - 1 , x , x + 1 , … , x + {s}_{1} \} \\ \{ D ( t , {s}_{2} ) \vert t = x - L , … , x - 1 , x , x + 1 , … , x + {s}_{2} \}\end{matrix} \qquad ( 6 )$$

wherein, the L is the length of the shot gradual transition to be detected, s₁<s₂. The meanings of other symbols are similar to those in formula (4).

Two sequences in the formula (6) may be used to detect whether a shot gradual transition with a length of L occurs before the x frame, that is, the x frame is the first frame of the shot following closely the shot gradual transition, and x−L frame is the last frame of the previous shot. It shall be noted that the L−1 gradual transition frames of the shot gradual transition with a length of L belong to none of the shots.

The s₁ and s₂ may be made as an odd number or an even number simultaneously. However, this embodiment is not limited thereto.

In the step 104, detect a shot transition in a video using an association of the inter-frame feature differential sequences {D(t, s₁)} and {D(t, s₂)}. For example, a shot transition may be detected using a classifier obtained by training with the two inter-frame feature differential sequences or mathematical transformations of the two inter-frame feature differential sequences as features. Wherein, the mathematical transformations of the two inter-frame feature differential sequences may be transformations constituted of, for example, an addition, a subtraction, a multiplication, a division, a power function, an exponent, a logarithm among corresponding inter-frame feature differential values of the two inter-frame feature differential sequences and the combination of the above mathematical transformations. The classifier is a classifier obtained by training with the inter-frame feature differential sequences {D(t, s₁)} and {D(t, s₂)} or mathematical transformations of the two inter-frame feature differential sequences as features based on a reliable sample set (for example, a sample set obtained through manual marks). The classifier may be obtained, for example, based on a support vector machine (SVM). After an input of the inter-frame feature differential sequences {D(t, s₁)} and {D(t, s₂)}, the classifier may output a probability of an occurrence of shot gradual transition with a length of L before x frame of the video. One of ordinary skill in the art can implement the specific training methods and using methods of the classifier after reading this Description, and thus detailed descriptions thereof are omitted here. In addition, in one example, before or after inputting the inter-frame feature differential sequences {D(t, s₁)} and {D(t,s₂)} obtained in step 102 to the classifier, processing and treating of data are performed in accordance with classification requirements.

In the above example, detect a shot gradual transition using an association of two inter-frame feature differential sequences. However, a shot gradual transition may be detected using three or more inter-frame feature differential sequences. In particular, in case of detecting a shot transition using three or more inter-frame feature differential sequences, the mathematical transformations of the inter-frame feature differential sequence that may be used in step 104 may be mathematical transformations of any two or more inter-frame feature differential sequences.

This embodiment is not limited to the construction method of the sequence association in the above formulae (6), for example, a sequence association as follows may be constructed for detecting a shot cut.

$$\{ \begin{matrix}\{ D ( t , {s}_{1} ) \vert t = x - L , … , x - 1 , x , x + 1 , … , x + {s}_{1} - 1 \} \\ \{ D ( t , {s}_{2} ) \vert t = x - L , … , x - 1 , x , x + 1 , … , x + {s}_{2} - 1 \}\end{matrix} \qquad ( 7 )$$

The meanings of the symbols in formula (7) are similar to those in the formula (6).

In the formula (6), the video segment corresponding to the sequence {D(t, s₁)} is the video segment from the frame x−1 to the frame x+s₁, that is, the length of the video segment is s₁+L+1, and the video segment corresponding to the sequence {D(t, s₂)} is the video segment from the frame x−1 to the frame x+s₂, that is, the length of the video segment is s₂+L+1. In the formula (5), the video segment corresponding to the sequence {D(t,s₁)} is the video segment from the frame x−L to the frame x+s₁−1, that is, the length of the video segment is s₁+L, and the video segment corresponding to the sequence {D(t, s₂)} is the video segment from the frame x−L to the frame x+s₂−1, that is, the length of the video segment is s₂+L+1. It can be seen that a length of a video segment which each inter-frame feature differential sequence corresponds to is determined based on a differential scale of the inter-frame feature differential sequence and a corresponding shot transition length to be detected. The sequence associations satisfying this rule will benefit a standardization of the sequence association. However, this embodiment is not limited thereto, and sequence associations not satisfying this rule may also be constructed

It shall be noted that if two frames of images corresponding to one inter-frame feature differential value are not in the same shot because of an existence of one shot gradual transition, this inter-frame feature differential value will be influenced by this shot gradual transition, or, this inter-frame feature differential value has a certain reflection to the existence of this shot gradual transition. For a shot gradual transition with a specific length, as to an inter-frame feature differential sequence with a larger differential scale, the span of the frames to which all the inter-frame feature differential values influenced by this shot gradual transition relate (that is, the length of the video segment corresponding to this sequence) is relatively large. Therefore, in order to make the limited number of extracted inter-frame features differential values more effective, a length of a video segment corresponding to an inter-frame feature differential sequence with a larger differential scale may be made to be greater than that of a video segment corresponding to an inter-frame feature differential sequence with a smaller differential scale. It can be seen that in the formulae (6) and (7), a length of a video segment corresponding to an inter-frame feature differential sequence with a larger differential scale is greater than that of a video segment corresponding to an inter-frame feature differential sequence with a smaller differential scale. Of course, the embodiment is not limited thereto, and sequence associations not satisfying this rule may also be constructed. For example, there may be only a part of (at least two) inter-frame feature differential sequences satisfying the rule among the plurality of inter-frame feature differential sequences.

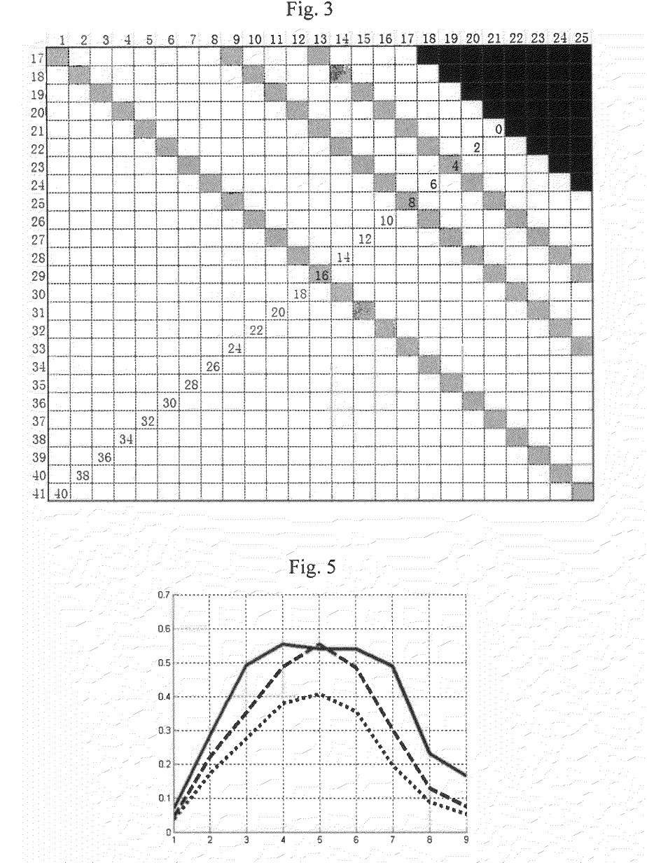

FIG. 3 is a schematic view of a multi-scale association feature used in the method for detecting a shot gradual transition. Wherein, each bin is representative of one inter-frame feature difference, and the row serial number and the column serial number corresponding thereto are respectively representative of serial numbers of the two images being performed with feature difference, and the figure in the bin is representative of a scale of the feature difference; the black bin represents that the feature difference corresponding thereto has an overlapping with a certain non-black bin located at its lower left side, and the charcoal grey bin represents that the corresponding inter-frame feature difference is adopted into multi-scale association features for cut detection. Features in this example may be used to detect a gradual transition where the x is 25 and the L is 8. Three scales which are respectively 4, 8 and 16 (instead of two) are used here.

In this embodiment, a differential scale of at least one inter-frame feature differential sequence of the plurality of inter-frame feature differential sequences may be made to be smaller than or equal to the shot transition length to be detected, and a differential scale of at least one inter-frame feature differential sequence of the plurality of inter-frame feature differential sequences may be made to be greater than or equal to the shot transition length to be detected, to obtain a better detection effect. For example, in the formulae (6) and (7), there may be s₁≦L, s₂≦L. However, the embodiment is not limited thereto.

It shall be noted that the above description relates to detecting whether a shot cut or a shot gradual transition with a length of L occurs before the x frame. In practical applications, detection may be performed for many times by changing a value of the x, and this process may be referred to as a scanning detection for a video. The scanning detection process may be continuous, that is, the x may be continuous values. In case that the requirement for precise is not very high, in order to reduce a calculation amount, a noncontinuous scanning detection may be performed, that is, the x may be noncontinuous values. It shall be noted that a calculation of the same inter-frame feature differential value may be involved in case of different values of the x. At this time, the calculation result may be used repeatedly, thereby avoiding a repetitive calculation.

### The Second Embodiment

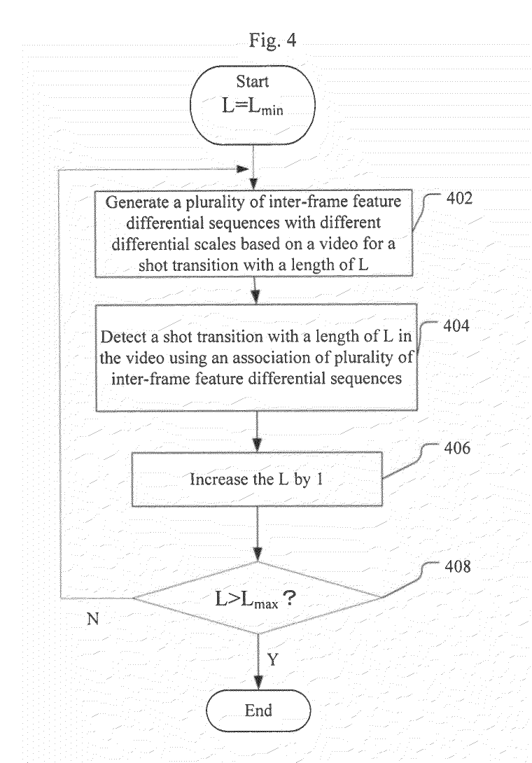

In the above first embodiment, a method for detecting separately a shot transition with a specific length is disclosed. In practical applications, a detection of a plurality of shot transitions with different lengths may be desired. One method is provided in this embodiment, and this method repeats the inter-frame feature differential sequence generation step and the shot transition detection step in the first embodiment to generate a plurality of groups of the plurality inter-frame feature differential sequences with respect to a plurality of possible shot transition lengths to be detected and to detect a shot transition with corresponding shot transition length by an association of the plurality of inter-frame feature differential sequences in each group. Specifically, FIG. 4 illustrates a method for detecting a shot transition in a video in accordance with the first embodiment of the present invention. As illustrated in FIG. 4, suppose that the minimum value and the maximum value of the length of the shot transition needed to be detected is Lₘᵢₙ, and Lₘₐₓ, respectively. The method of this embodiment is started to be executed from L=Lₘᵢₙ. In the step 402, generate a plurality of inter-frame feature differential sequences with different differential scales based on a video with respect to a shot transition with a length of L. In the step 404, detect a shot transition with a length of L in the video using an association of plurality of inter0 frame feature differential sequences. In the step 406, increase the L by 1. In the step 408, determine whether the L is greater than Lₘₐₓ, if so, return to step 402, if not, terminate the process. The steps 402 and the step 404 are similar to the steps 102 and 104 in the first embodiment, and detailed descriptions are omitted here.

In FIG. 4, the length L of the shot transition is continuous value. However, this embodiment is not limited thereto. The length L of the shot transition may be noncontinuous value. In addition, the order for detecting shot transitions with different shot transition length L is not limited to monotonically increasing, and may be, for example, of monotonically reducing or of random.

In case of using, for example, the association of the sequence in formula (6), suppose that as to the shot transition length L₁, the differential scales of the two sequences are respectively s₁₁ and s₁₂. As to the shot transition length L₂, suppose that the differential scales of the two sequences are respectively s₂₁ and s₁₂. Then, as to the shot transition length L₁, the lengths of the two sequences are respectively s₁₁+L₁+1 and s₁₂+L₁+1, and as to the shot transition length L₂, the lengths of the two sequences are respectively s₂₁+L₂+1 and s₂₂+L₂+1.

### The Third Embodiment

In order to facilitate to detect shot transitions with different lengths using the same functional module, it is hoped that features for detecting shot transitions with different lengths have the same dimension, i.e. the length of the inter-frame feature differential sequence. This embodiment propose to down-sample the inter-frame feature differential sequence with a longer length, thereby unifying feature dimensions of shot transitions with different lengths, so that the same module may be used. This embodiment also retains useful information in features of the longer shot transition. Of course, it may unify only feature dimensions of a part of (two or more) shot transitions with different lengths, and it is not necessary to unify feature dimensions of all shot transitions with different lengths.

In order to facilitate to unify feature dimensions of shot transitions with different lengths, in one example, the length of the shot transition whose feature dimension are desired to be unified is approximately proportional to a differential scale of a corresponding inter-frame feature differential sequence.

For example, suppose that the first inter-frame feature differential sequence group (that is, the sequence association) comprises n inter-frame feature differential sequences whose scales are respectively s₁₁, S₁₂, . . . , s₁ₙ for detecting a shot transition with a length of L₁; the second inter-frame feature differential sequence group comprises n inter-frame feature differential sequences whose scales are respectively s₂₁, s₂₂, . . . , s₂ₙ, for detecting a shot transition with a length of L₂; . . . ; the m^{th} inter-frame feature differential sequence group comprises n inter-frame feature differential sequences whose scales are respectively sₘ₁, sₘ₂, . . . , sₘₙ for detecting a shot transition with a length of Lₘ, wherein m is an integer greater than or equal to 2, n is an integer greater than or equal to 2, L₁, L₂, . . . , Lₘ is an integer greater than or equal to 1, and L₁<L₂< . . . <Lₘ, the S₂₁, s₂₂, . . . , s₂ₙ may be made to be respectively equal to

$$[ \frac{{L}_{2}}{{L}_{1}} ] {s}_{11} , [ \frac{{L}_{2}}{{L}_{1}} ] {s}_{12} , … , [ \frac{{L}_{2}}{{L}_{1}} ] {s}_{n} ,$$

s₃₁, s₃₂, . . . , s₃ₙ may be made to be respectively equal to

$$[ \frac{{L}_{3}}{{L}_{1}} ] {s}_{11} , [ \frac{{L}_{3}}{{L}_{1}} ] {s}_{12} , … , [ \frac{{L}_{3}}{{L}_{1}} ] {s}_{1 n} ,$$

sₘ₁, sₘ₂, . . . , sₘₙ may be made to be respectively equal to

$$[ \frac{{L}_{m}}{{L}_{1}} ] {s}_{11} , [ \frac{{L}_{m}}{{L}_{1}} ] {s}_{12} , … , [ \frac{{L}_{m}}{{L}_{1}} ] {s}_{1 n} ,$$

wherein, [.] is representative of an upper rounding operation, a lower rounding operation or rounding operation.

For obtaining the object of unifying feature dimensions of shot transitions with different lengths and compressing feature dimensions for shot transition detection, the longer inter-frame feature differential sequences is down-sampled to make down-sampled inter-frame differential sequences with different lengths have the same length. There are several methods which can be selected for down-sampling the inter-frame feature differential sequences, for example, the nearest sampling, the liner interposition, the Gauss window filter (weighted average), the spline interposition, etc. Those methods can be implemented by a person skilled in the art, and detailed descriptions are omitted here.

Other aspects of the method of this embodiment are similar to those of the second embodiments, and the detailed descriptions are omitted here.

### The Fourth Embodiment

In order to simplify an implementation of the method of the third embodiment, the same group of differential scales may be used for similar shot transition length. For example, the lengths of the shot transitions may be divided into segments, and shot transitions with a number of lengths in each segment are detected using an association feature of inter-frame feature differential sequences with the same scale. At this time, the scale of the inter-frame feature differential sequence which each segment corresponds to may be made to be approximately proportional to the shot transition length corresponding thereto. Hereinafter provides one possible combination of the shot transition length segment and the inter-frame feature differential sequence scale:

$$scale = \{ \begin{matrix}\{ 4 , 8 , 16 \} & if 5 \leq L \leq 8 \\ \{ 8 , 16 , 32 \} & if 9 \leq L \leq 16 \\ \{ 16 , 32 , 64 \} & if 17 \leq L \leq 32 \\ \{ 32 , 64 , 128 \} & if 33 \leq L \leq 64 \\ \{ 64 , 128 , 256 \} & if 65 \leq L \leq 128\end{matrix}$$

In the above example, the bigger the value of L is, the bigger the span of the segment corresponding thereto is. However, this embodiment is not limited thereto.

The method of down-sampling the inter-frame feature differential sequence has been described in the third embodiment, and will not be repeated here.

FIG. 5 illustrates an example of a three scale (8, 16, 32) association feature corresponding to a shot transition with a length of 16. The horizontal coordinates are representative of serial numbers of sampling points in the sampled sequences, and the longitudinal coordinates are representative of normalized inter-frame feature differential values. The solid line corresponds to an inter-frame feature differential sequence with a scale of 32, the dashed line corresponds to an inter-frame feature differential sequence with a scale of 16, and the dotted line corresponds to an inter-frame feature differential sequence with a scale of 8. It can be seen that the inter-frame feature differential sequences with the three scales are all down-sampled to be inter-frame feature differential sequences with a length of 9.

Other aspects of this embodiment are similar to the third embodiment, and detailed descriptions are omitted here.

From the first embodiment to the fourth embodiment, in the shot transition detection step, detect the shot transition using a classifier obtained by training. However, the present invention is not limited thereto. In the embodiments of the present invention, one or more of a peak value, a valley value, positions of a peak value point and a valley value point of each inter-frame feature differential sequence may be detected respectively, and a shot transition may be detected based on the one or more of the peak value, the valley value, the positions of the peak value point and the valley value point of each inter-frame feature differential sequence. For example, as illustrated in FIG. 5, positions of peak values of the three sequences are overlapped substantially, and an existence of a shot transition may be determined.

### Apparatus for Detecting a Shot Transition in a Video

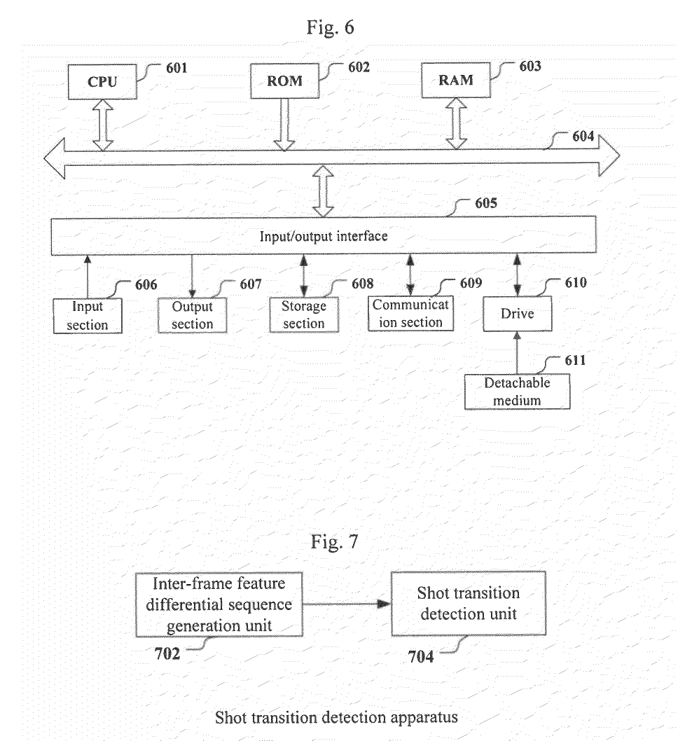

FIG. 6 illustrates graphically an exemplary structure of a computer equipment can be used for implementing the apparatus for detecting a shot transition in a video in accordance with the present invention.

In FIG. 6, a central process unit (CPU) 601 executes various processes based on a program stored in a Read-Only-Memory (ROM) 602 or a program loaded from a storage section 608 to the Random-Access-Memory (RAM) 603. In the RAM 603, data required for executing various processes by the CPU 601 etc are stored based on requirements.

The CPU 601, the ROM 602 and the RAM 603 are connected to each other via a bus 604. Input/output interface 605 is also connected to the bus 604.

The following components are connected to the input/output interface 605: an input section 606 including a keyboard, a mouse, etc; an output section 607 including a display, such as a cathode ray tube (CRT) display, a liquid crystal display (LCD), etc, and a speaker etc; a storage section 608 including a hard disc etc; and a communication section 609 including a network interface card such as an LAN card, a modem, etc. The communication section 609 executes a communication process via a network like the Internet.

Based on requirements, a drive 610 is also connected to the input/output interface 605. A detachable medium 611, such as a magnetic disc, an optical disc, a magneto-optical disk, a semiconductor memory, etc, is mounted on the drive 611, so that the computer program read from it is mounted in the storage section 608 based on requirements.

The program may be mounted to the computer device from the network like the Internet or the storage medium like the detachable medium 611.

It shall be understood by a person skilled in the art that such a storage medium is not limited to the detachable medium 611 stored with a program distributing separately from the device to provide a program to a user as illustrated in FIG. 6. The example of the detachable medium 611 includes a magnetic disc (including a floppy disc), an optical disc (including an optical disc Read-Only-Memory CD-ROM) and a digital versatile disc (DVD)), a magneto-optical disk (including a miniature disc (MD) (registered mark)) and a semiconductor memory. Or, the storage medium may be the hard disc included in the ROM 602, and the storage section 608, etc, wherein a program is stored the medium, and the medium is distributed to a user together with the devices including the medium.

Detailed descriptions of various specific embodiments of the apparatus for detecting a shot transition in a video of the present invention will be provided hereinafter, wherein, when relating to aspects of the method for detecting a shot transition in a video that has been described, a repetitive description is omitted here for simplification.

### The Fifth Embodiment

As illustrated in FIG. 7, a shot transition detection apparatus is provided, the apparatus comprising an inter-frame feature differential sequence generation unit 702 configured to generate a plurality of inter-frame feature differential sequences with different differential scales based on a video, wherein lengths of at least two inter-frame feature differential sequences of the plurality of inter-frame feature differential sequences are greater than or equal to 2; and a shot transition detection unit 704 configured to detect a shot transition in a video by an association of the plurality of inter-frame feature differential sequences.

In one example, at least two inter-frame feature differential sequences of the plurality of inter-frame feature differential sequences satisfy the following: a length of a video segment corresponding to an inter-frame feature differential sequence with a larger differential scale is greater than that of a video segment corresponding to an inter-frame feature differential sequence with a smaller differential scale.

In one example, a length of a video segment which each inter-frame feature differential sequence corresponds to is determined based on a differential scale of the inter-frame feature differential sequence and a corresponding shot transition length to be detected.

In one example, a differential scale of at least one inter-frame feature differential sequence of the plurality of inter-frame feature differential sequence is smaller than or equal to a shot transition length to be detected, and a differential scale of at least one inter-frame feature differential sequence of the plurality of inter-frame feature differential sequence is greater than or equal to the shot transition length to be detected.

In one example, the inter-frame feature differential sequence generation unit is configured to generate a plurality of groups of the plurality inter-frame feature differential sequences with respect to a plurality of possible different shot transition lengths to be detected, and the shot transition unit is configured to detect a shot transition with corresponding shot transition length by an association of the plurality of inter-frame feature differential sequences in each group, wherein, at least two shot transition lengths to be detected are approximately proportional to differential scales of corresponding inter-frame feature differential sequences.

In one example, the same group of differential scales is used for similar shot transition lengths.

In one example, the inter-frame feature differential sequence generation apparatus is further configured to down-sample a longer inter-frame feature differential sequence, so that lengths of inter-frame feature differential sequences of different groups which at least two different shot transition lengths to be detected correspond to are almost the same.

In one example, the shot transition detection unit is configured to detect a shot transition using a classifier obtained by training with the plurality of inter-frame feature differential sequences or mathematical transformations of the plurality of inter-frame feature differential sequences as features.

In one example, the shot transition detection unit is configured to detect one or more of a peak value, a valley value, positions of a peak value point and a valley value point of each inter-frame feature differential sequence respectively, and to detect a shot transition based on the one or more of the peak value, the valley value, the positions of the peak value point and the valley value point of each inter-frame feature differential sequence.

Regarding other details of shot transition detection apparatus, make reference to descriptions of the shot transition detection method, which is not repeated here.

According to one embodiment of the present invention, a computer-readable medium is provided, on which is stored computer instructions which, when executed by a computer, cause the computer to perform the above shot transition detection method.

Some of embodiments of the present invention are described in detail above. As can be understood by one of ordinarily skill in the art, all or any step or component of the method and apparatus of the present invention may be implemented in any calculating device (including processor, storage medium, etc) or in network of any calculating device with a hardware, a firmware, a software or their combinations. This can be implemented by one of ordinarily skill in the art with their basic programming skills after understanding the content of the present invention, and thus specific explanations are not provided here.

Moreover, apparently, when relating to possible external operations in the above description, any display device and any input device connected to any calculating device, corresponding interfaces and control programs will be used doubtlessly. In general, related hardware, software in a computer, a computer system or a computer network, and hardware, firmware, software or their combinations implementing various operation of the above method of the present invention constitute the device and various combined components of the present invention.

Therefore, based on the above understanding, the object of the present invention may be implemented through running one program or a group of programs on any information processing device. The information processing device may be a recognized universal device. Therefore, the object of the present invention may also be implemented only through a program product providing a program code to implement the method or the apparatus. That is, such a program product also constitutes the present invention, and a medium stored with or transmitting such a program product also constitutes the present invention. Apparently, the storage or transmission medium may be of any type of storage or transmission medium known to a person skilled in the art, or later to be developed. Therefore, it is not necessary for listing various storage or transmission mediums one by one.

In the apparatus and method of the present invention, apparently, each component or each step may be disassembled, combined and/or recombined after being disassembled. Those disassembling and/or recombining shall be regarded as equivalent solutions of the present invention. It shall be further pointed out that the step performing the above series of processes may be executed naturally in time order according to the order of the Description, but not necessarily executed in time order. Some steps may be executed in parallel or independently from each other. Meanwhile, in the Description of the embodiments of the present invention, features described and/or illustrated for one embodiment may be used in one or more other embodiments in the same or similar manner, be combined with features in other embodiments or replace features in other embodiments.

It shall be emphasized that the technical term “comprise/include” is used here to refer to an existence of a feature, an element, a step or a component, without excluding existences or attachments of one or more other features, elements, steps or components.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, device, means, methods and steps described in the Description. As one of ordinarily skill in the art will readily appreciate from the disclosure contained in the invention, processes, device, means, methods or steps presently existing or later to be developed, that perform substantially the same function or achieve substantially the same result as the corresponding embodiments described herein may be utilized according to the present invention. Accordingly, the appended claims are intended to include within their scope such processes, device, means, methods, or steps.

What is claimed is:

1. A shot transition detection method, comprising:
an inter-frame feature differential sequence generation step of generating a plurality of inter-frame feature differential sequences with different differential scales based on a video, wherein lengths of at least two inter-frame feature differential sequences of the plurality of inter-frame feature differential sequences are greater than or equal to 2; and
a shot transition detection step of detecting a shot transition in the video by an association of the plurality of inter-frame feature differential sequences.

2. The shot transition detection method of claim 1, wherein at least two inter-frame feature differential sequences of the plurality of inter-frame feature differential sequences satisfy the following: a length of a video segment corresponding to an inter-frame feature differential sequence with a larger differential scale is greater than that of a video segment corresponding to an inter-frame feature differential sequence with a smaller differential scale.

3. The shot transition detection method of claim 1, wherein a length of a video segment which each inter-frame feature differential sequence corresponds to is determined based on a differential scale of the inter-frame feature differential sequence and a corresponding shot transition length to be detected.

4. The shot transition detection method of claim 1, wherein a differential scale of at least one inter-frame feature differential sequence of the plurality of inter-frame feature differential sequences is smaller than or equal to a shot transition length to be detected, and a differential scale of at least one inter-frame feature differential sequence of the plurality of inter-frame feature differential sequences is greater than or equal to the shot transition length to be detected.

5. The shot transition detection method of claim 1, wherein the inter-frame feature differential sequence generation step and the shot transition detection step are repeated to generate a plurality of groups of the plurality inter-frame feature differential sequences with respect to a plurality of possible shot transition lengths to be detected and detect a shot transition with corresponding shot transition length by an association of the plurality of inter-frame feature differential sequences in each group,
wherein, at least two shot transition lengths to be detected are approximately proportional to differential scales of corresponding inter-frame feature differential sequences.

6. The shot transition detection method of claim 5, wherein the same group of differential scales is used for similar shot transition lengths.

7. The shot transition detection method of claim 5, wherein the inter-frame feature differential sequence generation step further comprises: down-sampling a longer inter-frame feature differential sequence, so that lengths of inter-frame feature differential sequences of different groups which at least two different shot transition lengths to be detected correspond to are almost the same.

8. The shot transition detection method of claim 1, wherein the shot transition detection step comprises: detecting a shot transition using a classifier obtained by training with the plurality of inter-frame feature differential sequences or mathematical transformations of the plurality of inter-frame feature differential sequences as features.

9. The shot transition detection method of claim 1, wherein, the shot transition detection step comprises: detecting one or more of a peak value, a valley value, positions of a peak value point and a valley value point of each inter-frame feature differential sequence respectively, and detecting a shot transition based on the one or more of the peak value, the valley value, the positions of the peak value point and the valley value point of each inter-frame feature differential sequence.

10. A shot transition detection apparatus, comprising:
an inter-frame feature differential sequence generation unit configured to generate a plurality of inter-frame feature differential sequences with different differential scales based on a video, wherein lengths of at least two inter-frame feature differential sequences of the plurality of inter-frame feature differential sequences are greater than or equal to 2; and
a shot transition detection unit configured to detect a shot transition in the video by an association of the plurality of inter-frame feature differential sequences.

11. The shot transition detection apparatus of claim 10, wherein at least two inter-frame feature differential sequences of the plurality of inter-frame feature differential sequences satisfy the following: a length of a video segment corresponding to an inter-frame feature differential sequence with a larger differential scale is greater than that of a video segment corresponding to an inter-frame feature differential sequence with a smaller differential scale.

12. The shot transition detection apparatus of claim 10, wherein a length of a video segment which each inter-frame feature differential sequence corresponds to is determined based on a differential scale of the inter-frame feature differential sequence and a corresponding shot transition length to be detected.

13. The shot transition detection apparatus of claim 10, wherein a differential scale of at least one inter-frame feature differential sequence of the plurality of inter-frame feature differential sequences is smaller than or equal to a shot transition length to be detected, and a differential scale of at least one inter-frame feature differential sequence of the plurality of inter-frame feature differential sequences is greater than or equal to the shot transition length to be detected.

14. The shot transition detection apparatus of claim 10, wherein the inter-frame feature differential sequence generation unit is configured to generate a plurality of groups of the plurality inter-frame feature differential sequences with respect to a plurality of possible shot transition lengths to be detected, and the shot transition unit is configured to detect a shot transition with corresponding shot transition length by an association of the plurality of inter-frame feature differential sequences in each group,
wherein, at least two shot transition lengths to be detected are approximately proportional to differential scales of corresponding inter-frame feature differential sequences.

15. The shot transition detection apparatus of claim 14, wherein the same group of differential scales is used for similar shot transition lengths.

16. The shot transition detection apparatus of claim 14, wherein the inter-frame feature differential sequence generation apparatus is further configured to down-sample a longer inter-frame feature differential sequence, so that lengths of inter-frame feature differential sequences of different groups which at least two different shot transition lengths to be detected correspond to are almost the same.

17. The shot transition detection apparatus of claim 10, wherein the shot transition detection unit is configured to detect a shot transition using a classifier obtained by training with the plurality of inter-frame feature differential sequences or mathematical transformations of the plurality of inter-frame feature differential sequences as features.

18. The shot transition detection apparatus of claim 10, wherein the shot transition detection unit is configured to detect one or more of a peak value, a valley value, positions of a peak value point and a valley value point of each inter-frame feature differential sequence respectively, and to detect a shot transition based on the one or more of the peak value, the valley value, the positions of the peak value point and the valley value point of each inter-frame feature differential sequence.

19. A computer-readable medium on which is stored computer instructions which, when executed by a computer, cause the computer to perform the method according to any one of claims 1 to 9 is recorded.
